(19) United States
(12) Patent Application Publication
(10) Pub. No.: US 2006/0165454 A1
(43) Pub. Date: Jul. 27, 2006

(54) Apparatus for classifying printed documents, an image forming device having the same, and a printed document classifying method thereof

(75) Inventor: Hyuck Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/335,541

(22) Filed: Jan. 20, 2006

(30) Foreign Application Priority Data
Jan. 27, 2005 (KR) 10-2005-0007707

(51) Int. Cl. G03G 15/00

(52) U.S. Cl. 399/405

(57) ABSTRACT

An apparatus for classifying printed documents so that the documents can be easily distinguished from one another, an image forming device having the same, and a printed document classifying method are disclosed. The apparatus includes a printed document separating unit and an operating unit. The printed document separating unit is arranged to be capable of moving to first and second positions near a tray upon which printed papers are discharged, and is used to classify printed documents. The operating unit moves the printed document separating unit from the first position to the second position when a last page of a specific printed document is completely output so that the printed document is distinguished. This apparatus classifies printed documents by using printed document identifiers when a last page of a printed document is completely output so that printed documents may be easily distinguished when several users use one image forming device and output many different documents at the same time.

### CROSS-REFERENCE TO RELATED APPLICATIONS

This application claims the benefit under 35 U.S.C. § 119(a) of Korean Patent Application No. 2005-7707, filed on Jan. 27, 2005, the entire contents of which are hereby incorporated by reference.

### BACKGROUND OF THE INVENTION

1. Field of the Invention

The present invention relates to an image forming device such as a copier, a printer and a facsimile. More particularly, the present invention relates to an apparatus for classifying printed documents so that printed documents may be easily distinguished, an image forming device having the same, and a printed document classifying method using the same.

2. Description of the Related Art

Generally, image forming devices such as copiers, printers and facsimile machines are shared by many users so that documents made by personal computers may be duplicated, printed, or facsimiled by one device.

In this case, however, if a user does not take a printed document duplicated, printed or faxed by the image forming device immediately, documents are output by the image forming device and piled up in a tray. Thus, when a user desires to find his or her printed document after a number of documents have been printed, the user needs to check all of the printed documents piled in the tray one by one by roughly judging the position of the desired document.

In addition, even if a user seeks to find a document immediately after the document is duplicated, printed or faxed by the image forming device, the document may not be easily found if other users are duplicating, printing or faxing other documents at the same time.

To address such problems, Japanese Laid-Open Publication H13-205899 discloses an image output device that outputs a work information paper IP on which printing work information 2 such as a work title, a worker name, a work date and a work time is printed, after sliding it a certain distance in a direction perpendicular to a discharged document, as shown in FIG. 1.

This image output device classifies printed documents D according to the work information paper IP corresponding to each document, so a user may identify and find his or her own document D among several documents D output by several users. However, since a work information paper IP must be printed and then discarded after being used for identifying the printed documents D, unnecessary time and paper are required to print such work information papers IP.

In addition, when each user takes his or her own printed document using the conventional image output device, the work information paper IP for classifying printed documents D is apt to be mixed with other printed documents D. In this case, the function of classifying the printed documents D is ineffective.

Accordingly, there is a continuing need for a document classifying device that classifies printed documents D and prevents them from being lost due to mixing of printed documents without requiring a separate work information paper IP.

### SUMMARY OF THE INVENTION

An aspect of the present invention is to address at least the above problems and/or disadvantages and to provide at least the advantages described below. Accordingly, an aspect of the present invention is to provide a printed document classifying apparatus for allowing a user to easily distinguish printed documents by classifying printed documents with a printed document separating unit, an image forming device having the apparatus, and a printed document classifying method using the apparatus.

In accordance with an aspect of the present invention, an apparatus for classifying printed documents is provided. The apparatus is applied to an image forming device, and includes a printed document separating unit and an operating unit. The printed document separating unit is arranged to be capable of moving to first and second positions near a tray upon which printed papers are discharged, and the printed document separating unit is used for classifying printed documents. An operating unit moves the printed document separating unit from the first position to the second position when a last page of a specific printed document is completely output so that the printed document is distinguished from other documents.

The printed document separating unit may include at least one printed document identifier that is provided with a flexible member that at least partially covers an output printed document, and a support member for supporting the flexible member.

The flexible member may comprises a flexible display for displaying printing work information including at least one of a worker name, a work document name and a work title. The support member may comprise a support body provided with a support rod that supports the flexible display. The flexible display preferably comprises an electronic paper (E-paper).

The operating unit may include at least one rotating solenoid having a motor having a pivoting axis supporting the printed document identifier and pivoting the printed document identifier between the first and second positions, and a stopper to restrict the movement of the printed document identifier within a range between the first and second positions.

The motor may include a rotor provided with a permanent magnet installed to the pivoting axis, and a stator having at least one coil wound around at least one bobbin positioned around the rotor with respect to an axis perpendicular to the pivoting axis of the rotor.

The stopper may include a first stopping protrusion restricting the printed document identifier not to move beyond the first position and a second stopping protrusion restricting the printed document identifier not to move beyond the second position.

The rotating solenoid may further include a biasing member for elastically biasing the printed document identifier towards the first position.

In addition, the apparatus for classifying printed documents may further include a switch unit used to return the printed document identifier to the first position after the output printed document is taken away.

In accordance with another aspect of the present invention, an image forming device includes a tray upon which printed papers are discharged, and a printed document classifying apparatus arranged near the tray and capable of being placed between printed documents to classify the printed documents.

The printed document classifying apparatus may include a printed document separating unit and an operating unit. The printed document separating unit is arranged to move to first and second positions near the tray, and the document separating unit is used to classify the printed documents. The operating unit moves the printed document separating unit from the first position to the second position when a last page of a specific printed document is completely output so that the printed document separating unit is placed on the output printed document.

The printed document separating unit may includes at least one printed document identifier that is provided with a flexible member that at least partially covers an output printed document, and a support member for supporting the flexible member.

The flexible member may comprises a flexible display for displaying printing work information including at least one of a worker name, a work document name and a work title. The support member may comprise a support body provided with a support rod that supports the flexible display. The flexible display preferably comprises an electronic paper (E-paper).

The operating unit may include at least one rotating solenoid having a motor having a pivoting axis supporting the printed document identifier and pivoting the printed document identifier between the first and second positions, and a stopper to restrict the movement of the printed document identifier within a range between the first and second positions.

The rotating solenoid may further have a biasing member for elastically biasing the printed document identifier towards the first position.

In addition, the image forming device may further include a switch unit used to return the printed document identifier to the first position after the output printed document is taken away.

In accordance with still another aspect of the invention, a method of classifying printed documents is provided. The method includes the steps of conducting a printing work, determining whether the printing work is completed, and arranging a printed document identifier on a printed document when the printing work is completed.

The method of classifying printed documents may further include the steps of extracting printing work information including at least one of a work document name, a work title and a worker name from data of a work document to be printed, and displaying the printing work information on the printed document identifier.

In addition, the method of classifying printed documents may further include the step of resetting the printed document identifier to an initial position after the printed document is taken away.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a perspective view of a printed document classifying method of a conventional image output device;

FIG. 2 is a block diagram of a laser printer with a printed document classifying apparatus according to the present invention;

FIG. 3 is a schematic sectional view of the laser printer of FIG. 2;

FIG. 4 is a partial front view taken along the line I-I of FIG. 3;

FIG. 5 is an exploded perspective view of a rotating solenoid and a printed document identifier of the laser printer of FIG. 3;

FIGS. 6A and 6B are partial side sectional views illustrating the operation of the printed document classifying apparatus of the laser printer shown in FIG. 3;

FIG. 7 is a partial perspective view illustrating the operation of a flexible display of a flexible member of the printed document identifier of the printed document classifying apparatus of the laser printer shown in FIG. 6B; and

FIG. 8 is a flowchart of the printed document classifying method of the laser printer shown in FIG. 2 and FIG. 3.

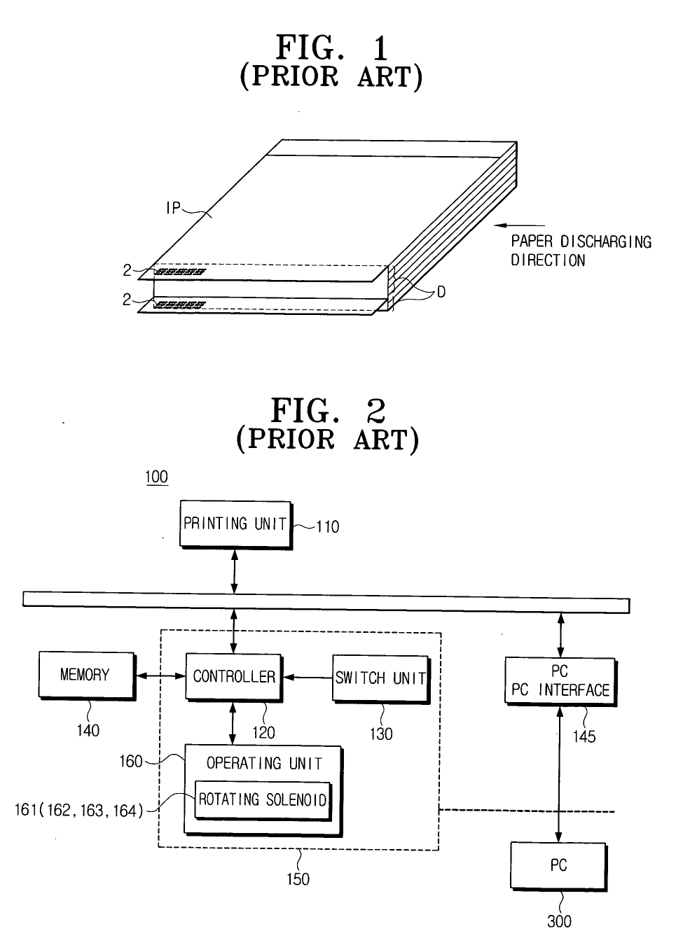

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

A printed document classifying apparatus, an image forming device having the apparatus, and a printed document classifying method using the apparatus according to exemplary embodiments of the present invention will now be described in more detail with reference to the drawings.

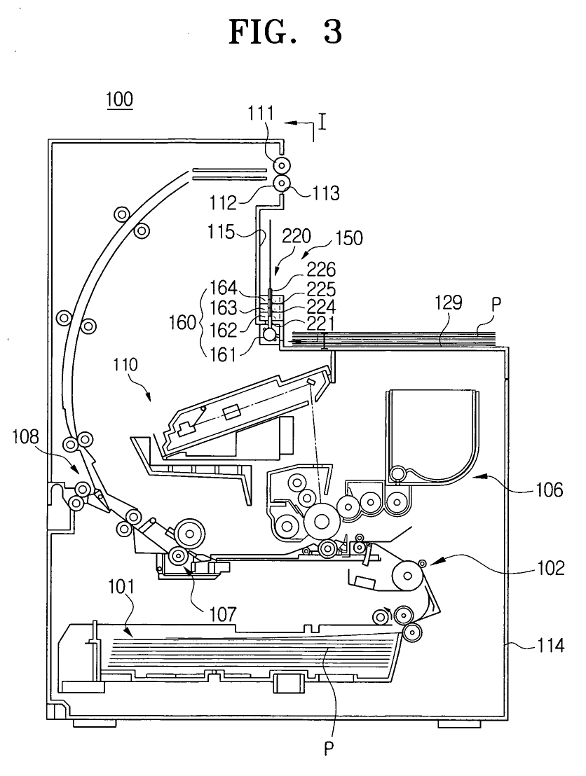

FIG. 2 is a schematic view of an image forming device having a printed document classifying apparatus according to an exemplary embodiment of the present invention.

The image forming device of the exemplary embodiment of the present invention is a laser printer 100. The laser printer 100 internally processes text or image data of a document that is prepared and transmitted by an application program of a computer 300, such as a PC (Personal Computer), and then prints the document.

The laser printer 100 includes a printing unit 110, a memory 140, a PC interface 145 and a printed document classifying apparatus 150.

As shown in FIG. 3, the printing unit 110 includes a loading unit 101 on which paper P is loaded, a carrying unit 102 for carrying paper P from the loading unit 101, an image forming unit 106 for forming a toner image on paper P carried by the carrying unit 102, a fixing unit 107 for fixing the toner image formed on the paper P with constant heat and pressure, and a discharging unit 108 for discharging the paper P on which the toner image is fixed. These components of the printing unit 110 are well known to those skilled in the art, and a detailed description is omitted for conciseness.

The PC interface 145 transmits information such as program data, protocol data and text or image data of documents from the computer 300 to the memory 140 according to a control signal of a controller 120.

The memory 140 temporarily stores or outputs the information transmitted through the PC interface 145 from the computer 300 and stores and outputs various control programs required for executing functions of the printer 100, by control of the controller 120.

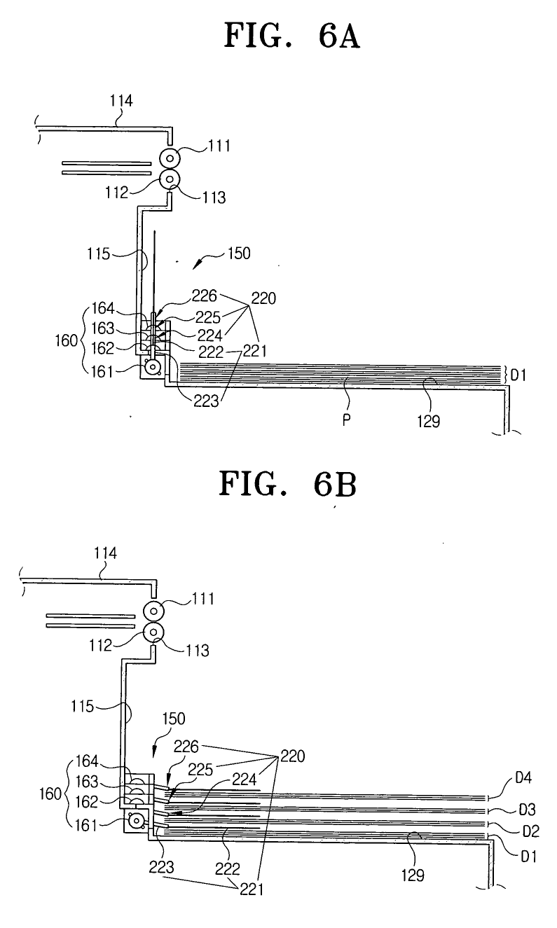

The printed document classifying apparatus 150 is configured so that printed document D1, D2, D3 or D4 (see FIG. 6B) discharged by a discharge roller 112 and a backup roller 111 through a paper discharge hole 113 of the discharging unit 108 and piled up in a stack on a tray 129 may be easily distinguished. The printed document classifying apparatus 150 includes a printed document separating unit 220, an operating unit 160, a switch unit 130 and a controller 120.

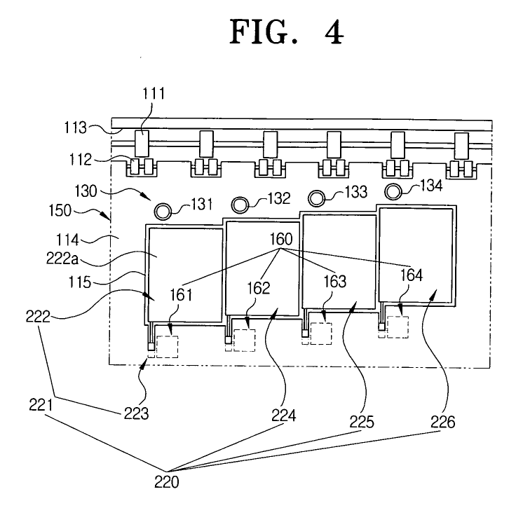

As shown in FIGS. 4 and 6B, the printed document separating unit 220 is placed on the printed document D1, D2, D3 and D4 and classifies the printed documents D1, D2, D3 and D4. The printed document separating unit 220 has four printed document identifiers 221, 224, 225 and 226.

Each of printed document identifiers 221, 224, 225 and 226 has a flexible member 222 and a support member 223, and is arranged on a recessed portion 115 formed on a main frame 114 below the paper discharge hole 113 to be movable to first or second positions. The first position is a standby position where the flexible member 222 of each printed document identifier 221, 224, 225 or 226 is inserted into the recessed portion 115 as shown in FIG. 6A, while the second position is an extended position where the flexible member 222 of each printed document identifier 221, 224, 225 or 226 is placed on the corresponding printed document D1, D2, D3 or D4 as shown in FIG. 6B.

As shown in FIG. 4, the flexible member 222 of each printed document identifier 221, 224, 225 or 226 is arranged to become higher when moving from left to right in the recessed portion 115, thereby forming a stepped shape. Since the height of printed documents D1, D2, D3 or D4 piled in the tray 129 increases as they are printed (as shown in FIG. 6B), the flexible member 222 is arranged to become higher when moving from left to right so that the flexible member 222 of each printed document identifier 221, 224, 225 or 226 may be suitably placed on the corresponding printed documents D1, D2, D3 and D4 according to its height.

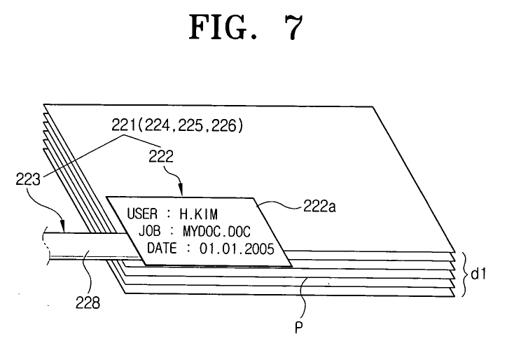

In addition, the flexible member 222 of each printed document identifier 221, 224, 225 and 226 is a rectangular plate that covers at least part of the top of the printed documents D1, D2, D3 and D4 so as to classify printed documents D1, D2, D3 and D4 (see FIG. 7). The flexible members are preferably arranged in the recessed portion 115 at a regular interval so that at least the printed document identifiers 221 and 226 positioned at both sides are partially exposed out of the top of the printed documents D1, D4.

The flexible member 222 of each printed document identifier 221, 224, 225 or 226 may be selectively arranged so that they are subsequently overlapped within an allowable limit for operation and installation of rotating solenoids 161, 162, 163 and 164 of an operating unit 160 described later. In this case, the flexible members 222 of all printed document identifiers 221, 224, 225 and 226 may be partially exposed out of the top of the printed documents D1, D2, D3 and D4 while covering one corner of the top of the printed documents D1, D2, D3 and D4. Accordingly the printed documents D1, D2, D3 and D4 may be more easily distinguished.

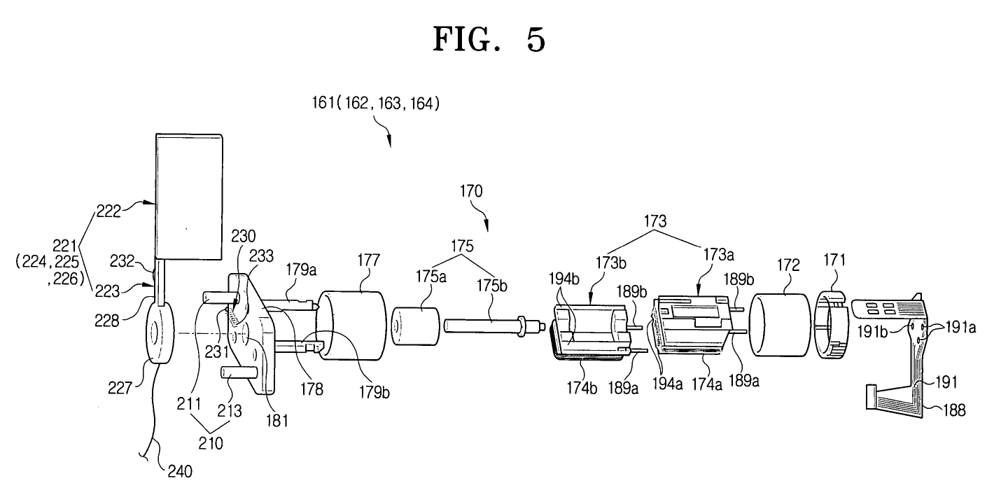

As shown in FIG. 7, the flexible member 222 is preferably formed of a flexible display 222a for displaying printing work information including a worker name, a work document name, a work title, a work date and a work time by control of the controller 120. The printing work information is extracted from a work document data including text or image data transmitted from the computer 300 by the controller 120 connected to the flexible display 222a via a lead wire 240 (see FIG. 5).

The flexible display 222a may be a micro capsule-type electronic paper (E-paper) which gives the appearance of ink using small balls or capsules less than 0.1 mm, or a flexible display-type electronic paper that gives the appearance of paper by making a flat plate display such as an LCD thinner.

Alternatively, the flexible member 222 may be a thin, plastic rectangular plate member or the like instead of the flexible display 222a, so as to only classify the printed documents D1, D2, D3 and D4 without displaying the printing work information.

The support member 223 of each printed document identifier 221, 224, 225 or 226 supports the flexible display 222a of the corresponding flexible member 222 on a pivoting axis 175b of a rotor 175 of the corresponding rotating solenoid 161, 162, 163 or 164. The support member 223 is configured with a circular support 227 that fixes the flexible display 222a of the flexible member 222 to the pivoting axis 175b of the rotor 175. The circular support 227 is formed with plastic or the like to be capable of bending and has a support rod 228 supporting and fixing the flexible display 222a of the flexible member 222. The flexible display 222a is connected to a circuit board (not shown) forming the controller 120 via the lead wire 240 embedded in the support rod 228 of the circular support 227.

The operating unit 160 moves the flexible display 222a of the flexible member 222 of each printed document identifier 221, 224, 225 and 226 from the first position to the second position so that the flexible display 222a may be placed on the corresponding printed document D1, D2, D3 or D4, and is configured with four rotating solenoids 161, 162, 163 and 164.

Each of the rotating solenoids 161, 162, 163 and 164 is controlled by the controller 120 to move one flexible display 222a from the first position to the second position whenever a corresponding document D1, D2, D3 or D4 of one document file prepared by the computer 300 is completely printed.

As shown in FIG. 5, each of the rotating solenoids 161, 162, 163 and 164 is provided with a motor 170 and a stopper 210.

The motor 170 includes a rotor 175, a stator 173, first and second bobbin supports 179a and 179b, a tape 172, a yoke ring 177, a cover 171 and a flexible printed circuit board (FPCB) 188. The rotor 175 has a cylindrical permanent magnet 175a and a pivoting axis 175b fixing the permanent magnet 175a. At one end of the pivoting axis 175b on which a base plate 178 is protruded through a hole 181, a rotating body 227 of the flexible member 223 is fixed. The stator 173 has first and second bobbins 173a and 173b around which first and second coils 174a and 174b positioned around the rotor 175 are wound. The first and second coils 174a and 174b of the first and second bobbins 173a and 173b are respectively wound around the first and second bobbins 173a and 173b with respect to an axis perpendicular to the pivoting axis 175b of the rotor 175. The first and second bobbin supports 179a and 179b are formed on the base plate 178 so that, when the first and second bobbins 173a and 173b are coupled with each other, they are inserted into vertical grooves 194a, 194b vertically formed at both edges of opposite surfaces thereof to support the first and second bobbins 173a and 173b. The tape 172 wraps around the first and second bobbins 173a and 173b supported by the first and second bobbin supports 179a and 179b. The yoke ring 177 is arranged around the tape 172, and the cover 171 seals the yoke ring 177. The FPCB 188 has input and output terminals 191a and 191b connected to input and output terminals 189a and 189b of the first and second coils 174a and 174b wound around the first and second bobbins 173a and 173b, together with wires 191. The wires 191 are connected to the circuit board including the controller 120.

Thus, if a power source applies a forward or reverse electric current (for example, a forward current) to the first and second coils 174a and 174b through the input terminal 191a of the wiring 191 of the FPCB 188 and the input terminal 189a of the first and second coils 174a and 174b, the first and second coils 174a and 174b generate a magnetic field in any of upper and lower directions (for example, in a lower direction) of the axis perpendicular to the pivoting axis 175b of the rotor 175 along which a forward current flows through the coils 174a and 174b. Accordingly, the rotor 175 of the motor 170 rotates in one direction (for example, in a clockwise direction) within a certain angular range (for example, within about 120°) by means of the magnetic field in a lower direction, so the flexible display 222a of the flexible member 222 is moved from the first position (see FIG. 6A) to the second position (see FIG. 6B) by means of the support rod 228 of the support body 227.

In contrast, if an opposite current (for example, a reverse current) is applied from the power source to the first and second coils 174a and 174b by control of the controller 120, the first and second coils 174a and 174b generates a magnetic field in an upper direction of the axis perpendicular to the pivoting axis 175b of the rotor 175. Accordingly, the rotor 175 is rotated about 120° in a counterclockwise direction by means of the magnetic field in the upper direction so that the flexible display 222a is moved from the second position (see FIG. 6B) to the first position (see FIG. 6A). At this time, the magnitude of the magnetic field of the first and second coils 174a and 174b is preferably set so that the flexible display 222a of the flexible member 222 may be returned to the first position only when a certain weight, for example, about three or four sheets of paper for one document D1, D2, D3 or D4, is loaded on the flexible display 222a. In this case, if a user does not take the printed paper D1, D2, D3 or D4, the flexible display 222a of the flexible member 222 does not return to the first position even though a reverse current is applied to the first and second coils 174a and 174b.

The pivoting range of the flexible display 222a is about 120°, and a stopper 210 restricts the rotor 175 to prevent it from rotating beyond about 120°. The stopper 210 has first and second stopping protrusions 211, 213.

The first and second stopping protrusions 211, 213 are formed in a rotating path of the support rod 228 of the support body 227 at base plate 178 at an interval of about 120°. Thus, though the rotor 175 is urged to rotate beyond the about 120° range by means of magnetic field, rotation of the support rod 228 is restricted by the first and second stopping protrusions 211, 213. Accordingly, the flexible display 222a is stopped at the first and second positions.

Each of the rotating solenoids 161, 162, 163 and 164 may further include a biasing member 230 that urges the support rod 228 of the support body 227 toward the first stopping protrusion 211 so that the corresponding flexible display 222a of the flexible member 222 is urged towards the first position when the power of the printer 100 is turned off.

The biasing member 230 is comprised of a tension spring 231. The tension spring 231 is supported by a first support boss 232 formed on the support rod 228 at one end, and the other end is supported by a second support boss 233 formed on the base plate 178. The elasticity of the tension spring 231 is preferably set according to the magnitude of the magnetic field of the first and second coils 174a and 174b so that the flexible display 222a may be returned to the first position only when a certain weight, for example, about three or four sheets of paper for one document D1, D2, D3 or D4, is loaded on the flexible display 222a of the flexible member 222. In this case, if the printer 100 turns off when the printed paper D1, D2, D3 or D4 has not been taken by a user, the flexible display 222a of the flexible member 222 does not return to the first position.

As shown in FIG. 4, the switch unit 130 is used to return the flexible display 222a of the flexible member 222 of the corresponding printed document identifier 221, 224, 225 or 226 to the first position after a user takes away a printed document D1, D2, D3 or D4. The switch unit 130 has four reset switches 131, 132, 133 and 134 installed near to the recessed portion 115 of the main frame 114 to which each printed document identifier 221, 224, 225 or 226 is installed.

Each of reset switches 131, 132, 133 and 134 is connected to the controller 120 so that it may output a reset signal to the controller 120 when being pushed by a user. If a user presses a certain reset switch 131, 132, 133 or 134 to output a reset signal, the controller 120 controls the power source so as to apply an opposite current, or a current in an opposite direction, to the first and second coils 174a and 174b of the motor 170 of the corresponding rotating solenoid 161, 162, 163 or 164, or stop the supply of power. As a result, the flexible display 222a of the corresponding support member 221, 224, 225 or 226 is moved from the second position (see FIG. 6B) to the first position (see FIG. 6A) by means of the rotating force of the rotor 175 rotating in a counterclockwise direction, or the elasticity of the tension spring 231 of the biasing member 230 that pulls the support rod 228 of the support body 227 toward the first stopping protrusion 211.

The controller 120 controls the printer 100 as a whole according to a preset control program.

In addition, as mentioned above, the controller 120 extracts printing work information from the work document data transmitted from the computer 300 during the printing work, and then applies a forward current to the first and second coils 174a and 174b of the motor 170 of the corresponding rotating solenoid 161, 162, 163 or 164 so that one printed document identifier 221, 224, 225 or 226 is operated from the first position to the second position whenever a last page of one document is completely output, and at the same time controls the extracted printing work information so that it is displayed on the flexible display 222a of the flexible member 222 of the corresponding printed document identifier 221, 224, 225 or 226.

In addition, when a user pushes the corresponding reset switch 131, 132, 133 or 134 of the corresponding switch unit 130 after taking away a printed document D1, D2, D3 or D4, the controller 120 applies a backward current to the first and second coils 174a and 174b of the motor 170 of the corresponding rotating solenoid 161, 162, 163 or 164 so that the flexible display 222a of the corresponding printed document identifier 221, 224, 225 or 226 is operated from the second position to the first position, or to stop the supply of power according to the reset signal of the reset switch 131, 132, 133 or 134.

In the above description, the controller 120 operates one printed document identifier 221, 224, 225 or 226 to move it from the first position to the second position whenever the last page of one document is completely output. It is also possible, however, to control a printed document identifier 221, 224, 225 or 226 to move from the first position to the second position only when a document currently being printed and the next document to be printed are from different persons.

In addition, the above described exemplary embodiment of the present invention is provided with four printed document identifiers 221, 224, 225 and 226, four rotating solenoids 161, 162, 163 and 164 and four reset switches 131, 132, 133, 134. The present invention is not limited four sets of identifiers, rotating solenoids, and reset switches. More or less than four may be used as desired.

Furthermore, the particular arrangement of the printed document classifying apparatus 150 of the present invention is not limited to the above-described exemplary embodiment. That is to say, the printed document separating unit 220 and the operating unit 160 may be arranged at any suitable positions around the tray 129, at which they may be placed on printed documents D1, D2, D3 and D4 to be capable of classifying the printed documents D1, D2, D3 and D4.

Moreover, although the printed document classifying apparatus 150 in the above description is a laser printer 100, the present invention may be applied to facsimiles, copiers, ink-jet printers and the like using the same principle.

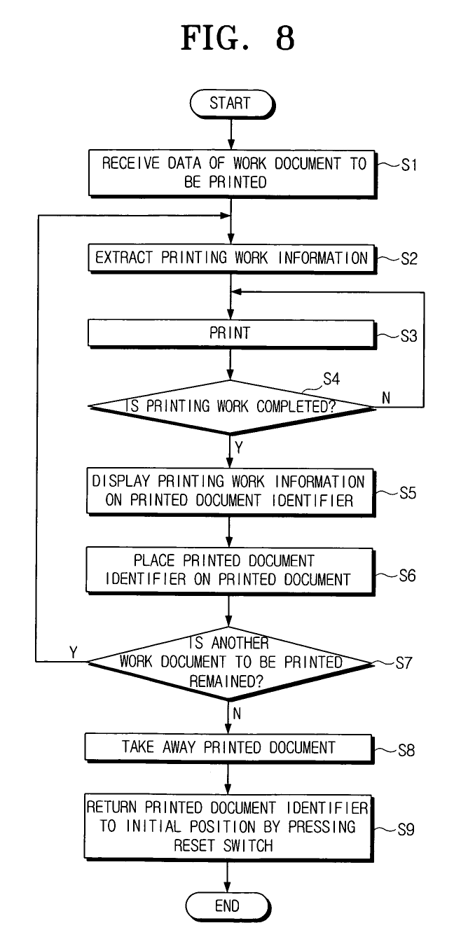

The process of the printed document classifying method using the laser printer 100 equipped with the printed document classifying apparatus 150 according to the exemplary embodiments of the present invention will now be described in detail with reference to FIGS. 2 to 8.

First, after the printer 100 turns on, the controller 120 receives work document data (including text and image data for a specific work document prepared using an application program of the computer 300) through the PC interface 145 together with a printing command from the computer 300 (S1).

Subsequently, the controller 120 extracts printing work information including a worker name, a work title, a work document name, work data and a work time of the work document to be printed from the work document data received from the computer 300, and then stores it in the memory 140 (S2).

After that, the controller 120 controls each component of the printing unit 110 to conduct printing work for the work document data received from the computer 300 (S3).

While the work document data is printed on a paper P and output to the tray 129 through the paper discharge hole 113, the controller 120 determines whether the printing work for the work document data, for example, a last page of the printed document D1, is completely printed (S4).

If it is determined that the last page of the printed document D1 is completely output, the controller 120 selects a usable printed document identifier, for example, a printed document identifier 221, and then outputs a control signal to the flexible display 222a of the flexible member 222 of the selected printed document identifier 221 to display the printing work information extracted in the step S2 (S5).

After that, in order to move the flexible display 222a, on which the printing work information is displayed, from the first position to the second position, the controller 120 applies any of a forward or reverse current, for example, a forward current, to the first and second coils 174a and 174b of the motor 170 of the corresponding rotating solenoid 161. As a result, the rotor 175 of the motor 170 rotates in one direction, for example, in a clockwise direction, against the elastic force of the tension spring 231 within a certain angular range, for example, within about 120°, by means of magnetic field until the support rod 228 of the support body 227 is stopped by the second stopping protrusion 213, thereby making the flexible display 222a pivot from the first position to the second position (S6).

After that, the controller 120 determines whether another work document data to be printed remains (S7).

If there remains more work document data to be printed as a result of determination in the step S6, the controller 120 repeats the procedure after the step S2. If there is no more work document data to be printed, the controller 120 stops the printing work.

After a user takes away his or her own printed document D1 and then presses the reset switch 131 positioned near the corresponding printed document identifier 221, the controller 120 applies an opposite current among the forward and reverse currents, for example, a reverse current, to the first and second coils 174a and 174b of the corresponding motor 170 so as to move the corresponding flexible display 222a from the second position to the first position, or stops the supply of current according to the reset signal. As a result, the flexible display 222a is rotated in an opposite direction, for example, in a counterclockwise direction, within a certain angular range, for example, about 120° by means of the magnetic field of the first and second coils 174a and 174b applied to the rotor 175 of the motor 170 and/or the elastic force of the tension spring 231 of the biasing member 230 until the support rod 228 of the support body 227 is stopped by the first stopping protrusion 211, thereby returning from the second position to the first position.

At this time, if there are at least two printed documents D2, D3 and/or D4 are still remained on the flexible display 222a, since the magnitude of the magnetic field of the first and second coils 174a and 174b rotating the pivoting axis 175b of the rotor 175 and the elastic force of the tension spring 231 pulling the support rod 228 of the support body 227 are set to possibly return the flexible display 222a to the first position only when a certain weight, for example, about 3 or 4 papers P or less papers P are placed therein, the flexible display 222a is not returned to the first position.

As described above, the printed document classifying apparatus, the image forming device equipped with the apparatus and the printed document classifying method using the apparatus according to the present invention classifies printed documents according to work documents or workers by use of the printed document identifiers when a last page of a printed document is completely output, so printed documents may be easily distinguished when several users use one image forming device in common and output a plurality of work documents at the same time.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for classifying printed documents in an image forming device, the apparatus comprising:
a printed document separating unit that moves between a first position and a second position, the printed document separating unit being located near a tray upon which printed papers are discharged, the printed document separating unit being used to classify printed documents; and
an operating unit for moving the printed document separating unit from the first position to the second position when a last page of a specific printed document is completely output.

2. The apparatus for classifying printed documents according to claim 1, wherein the printed document separating unit comprises at least one printed document identifier that is provided with:
a flexible member for covering an output printed document; and
a support member for supporting the flexible member.

3. The apparatus for classifying printed documents according to claim 2, wherein
the flexible member is sized to partially cover the output printed document.

4. The apparatus for classifying printed documents according to claim 3, wherein
the flexible member comprises a flexible display for displaying printing work information including at least one of a worker name, a work document name and a work title.

5. The apparatus for classifying printed documents according to claim 4, wherein
the flexible display comprises an electronic paper (E-paper).

6. The apparatus for classifying printed documents according to claim 2, wherein
the support member comprises a support body provided with a support rod that supports the flexible display.

7. The apparatus for classifying printed documents according to claim 1, wherein the operating unit comprises at least one rotating solenoid comprising:
a motor having a pivoting axis supporting the printed document identifier and pivoting the printed document identifier between the first and second positions; and
a stopper to restrict the movement of the printed document identifier within a range between the first and second positions.

8. The apparatus for classifying printed documents according to claim 7, wherein
the rotating solenoid further comprises a biasing member for elastically biasing the printed document identifier towards the first position.

9. The apparatus for classifying printed documents according to claim 7, further comprising:
a switch unit for returning the printed document identifier to the first position after the output printed document is taken away.

10. An image forming device, comprising:
a tray upon which printed papers are discharged; and
a printed document classifying apparatus arranged near the tray and capable of being placed between printed documents to classify the printed documents.

11. The image forming device according to claim 10, wherein the printed document classifying apparatus comprises:
a printed document separating unit that moves between a first position and a second position, the printed document separating unit being used to classify printed documents; and
an operating unit for moving the printed document separating unit from the first position to the second position when a last page of a specific printed document is completely output so that the printed document separating unit is placed on the output printed document.

12. The image forming device according to claim 11, wherein the printed document separating unit comprises at least one printed document identifier that is provided with:
a flexible member for covering an output printed document; and
a support member for supporting the flexible member.

13. The apparatus for classifying printed documents according to claim 12, wherein
the flexible member is sized to partially cover the output printed document.

14. The image forming device according to claim 11, wherein the operating unit comprises at least one rotating solenoid comprising:
a motor having a pivoting axis supporting the printed document identifier and pivoting the printed document identifier between the first and second positions; and
a stopper to restrict the movement of the printed document identifier within a range between the first and second positions.

15. The image forming device according to claim 14,
the rotating solenoid further comprises a biasing member for elastically biasing the printed document identifier towards the first position.

16. The image forming device according to claim 14, further comprising:
a switch unit used for operating the printed document identifier to be returned to the first position the output printed document is taken away.

17. A method of classifying printed documents, comprising the steps of:
conducting a printing work;
determining whether the printing work is completed; and
arranging a printed document identifier on a printed document when the printing work is completed.

18. The method of classifying printed documents according to claim 17, further comprising the steps of:
extracting printing work information including at least one of a work document name, a work title and a worker name from data of a work document to be printed; and
displaying the printing work information on the printed document identifier.

19. The method of classifying printed documents according to claim 17, further comprising the step of:
resetting the printed document identifier to an initial position after the printed document is taken away.
